(19) United States
(12) Patent Application Publication
(10) Pub. No.: US 2014/0320239 A1
(43) Pub. Date: Oct. 30, 2014

(54) MULTI-MODE BANDPASS FILTER

(71) Applicant: Wave Electronics Co., Ltd., Suwon (KR)

(72) Inventors: Yun-Hong PARK, Seoul (KR); Dal Ahn, Seoul (KR)

(21) Appl. No.: 14/324,800

(22) Filed: Jul. 7, 2014

Related U.S. Application Data
(63) Continuation of application No. PCT/KR2013/000075, filed on Jan. 7, 2013.

(30) Foreign Application Priority Data
Jan. 5, 2012 (KR) 10-2012-0001631

(51) Int. Cl. H01P 1/20

(52) U.S. Cl. CPC H01P 1/2002
USPC 333/202

(57) ABSTRACT

The present invention can couple multiple resonances through a change in the shape of a part of a dielectric resonance element or of a cavity so as to couple energy between resonances when generating the multiple resonances, such as dual or triple resonances, of the dielectric resonance element in one cavity, thereby simplifying the shape and reducing the size thereof. In addition, a dielectric resonance element is manufactured into the shape of a doughnut so as to generate triple resonances in one cavity, thereby facilitating the manufacture of the dielectric resonance element and the emission of heat from the dielectric resonance element.

### CROSS-REFERENCE TO RELATED APPLICATIONS

This application is a continuation of International Application No. PCT/KR2013/000075 filed on Jan. 7, 2013, which claims a priority to Korean Application No. 10-2012-0001631 filed on Jan. 5, 2012, which applications are incorporated herein by reference.

### TECHNICAL FIELD

The present invention relates to a high frequency filter, and more particularly, to a multi-mode bandpass filter that implements multiple resonances in a single cavity.

### BACKGROUND ART

In general, in order to implement a filter in a ultra-high frequency, a cavity filter having a cavity, a wave guide filter, a dielectric filter, or the like is implemented because a high power may be implemented and selectivity (Q: Quality factor) is high. Among them, the dielectric filter is mainly used in order to improve the selectivity in a similar cavity volume. However, such a dielectric filter has disadvantages in that a manufacturing cost is high and a weight becomes heavy since a dielectric resonance element should be introduced into a cavity.

In order to overcome these disadvantages, efforts to implement multiple resonances in a single cavity have been made for a long time, as in U.S. Pat. No. 4,675,630. However, as illustrated in FIG. 1 which is the same as the representative figure of the US patent, a plurality of coupling screws for couple energies, as indicated by reference numerals 16, 18, and 20 should be fabricated in a direction of 45 degrees from edges of a cavity in order to form a filter characteristic with a plurality of resonances within a single cavity. Thus, there is a difficulty in fabricating the cavity, which causes a cost increases. In addition, because adjustment screws are distributed in various directions, a practically usable space is reduced.

In FIG. 1, reference numeral 4 is a wave guide cavity, reference numeral 6 is a resonance element, reference numerals 8 and 10 are coaxial probes, reference numeral 14 is a low dielectric constant support, and reference numerals 22, 24, and 26 are tuning screws.

### SUMMARY

An object of the present invention is to facilitate implementation of energy coupling in order to implement a filter characteristic by generating multiple resonances within a single cavity.

Another object of the present invention is to reduce the manufacturing cost of a cavity by facilitating the implementation of energy coupling and to achieve additional miniaturization by reducing an implementation space.

Another object of the present invention is to facilitate the manufacturing of a dielectric resonance element and dissipation of heat generated from the dielectric resonance element when multiple resonances are generated in a single cavity, by fabricating the dielectric resonance element.

A multi-mode bandpass filter includes a dielectric resonance element of which the shape is partially modified for energy coupling respective resonances when multiple resonances are formed in a single cavity using a dielectric resonance element.

In addition, as the same purpose, a multi-mode bandpass filter includes a cavity of which the shape is partially deformed for energy coupling of respective resonances without modifying the shape of the dielectric resonance element.

A multi-mode bandpass filter includes a dielectric resonance element so as to generate triple resonances in a single cavity in which the dielectric resonance element is formed in a doughnut shape so as to facilitate the manufacturing of the dielectric resonance element and dissipation of heat.

When multiple resonances are implemented using a single cavity, it is possible to simplify a coupling structure for energy coupling between respective resonance modes.

Due to this, it is possible to overcome a structural restriction according to the coupling structure when implementing multiple resonances using a plurality of cavities. Thus, a multi-mode bandpass filter may be freely implemented without a structural restriction.

In addition, due to the simplification of a cavity or cavities, it is possible to reduce a manufacturing cost of the cavity or cavities and to miniaturize the cavity or cavities.

In addition, when triple resonances are implemented using a single cavity, the dielectric resonance element is manufactured in a doughnut shape which facilitates the manufacturing of the multi-mode bandpass filter to reduce the manufacturing cost and dissipation of heat generated from the dielectric resonance element to stably and reliably operate a product.

### BRIEF DESCRIPTION OF THE DRAWINGS

FIG. 1 is a perspective view of a conventional multiple resonance band filter;

FIG. 2a is a perspective view of a multi-mode bandpass filter according to a first exemplary embodiment of the present invention;

FIG. 2b is a transmissive perspective view of the multi-mode bandpass filter according to the first exemplary embodiment of the present invention;

FIG. 2c is a graph representing a characteristic measured for the multi-mode bandpass filter according to the first exemplary embodiment;

FIG. 3a is a perspective view of a multi-mode bandpass filter according to a second exemplary embodiment of the present invention;

FIG. 3b is a transmissive perspective view of the multi-mode bandpass filter according to the second exemplary embodiment of the present invention;

FIG. 3c is a graph representing a characteristic measured for the multi-mode bandpass filter according to the second exemplary embodiment;

FIG. 4a is a transmissive perspective view of the multi-mode bandpass filter according to a third exemplary embodiment of the present invention;

FIG. 4b is a characteristic simulation graph of the multi-mode bandpass filter according to the third exemplary embodiment of the present invention;

FIG. 5 is a transmissive perspective view of the multi-mode bandpass filter according to a fourth exemplary embodiment of the present invention;

FIG. 6 is a transmissive perspective view of the multi-mode bandpass filter according to a fifth exemplary embodiment of the present invention;

FIG. 7 is a transmissive perspective view of the multi-mode bandpass filter according to a sixth exemplary embodiment of the present invention;

FIG. 8 is a transmissive perspective view of the multi-mode bandpass filter according to a seventh exemplary embodiment of the present invention; and

FIGS. 9a and 9b are graphs comparatively illustrating characteristics measured for multi-mode bandpass filters according to features of the present invention.

### DETAILED DESCRIPTION

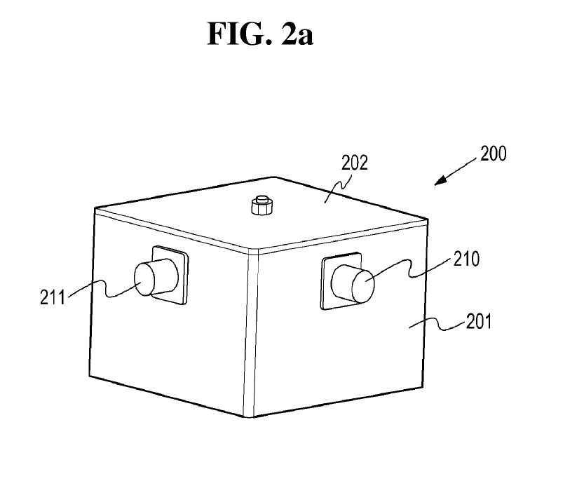

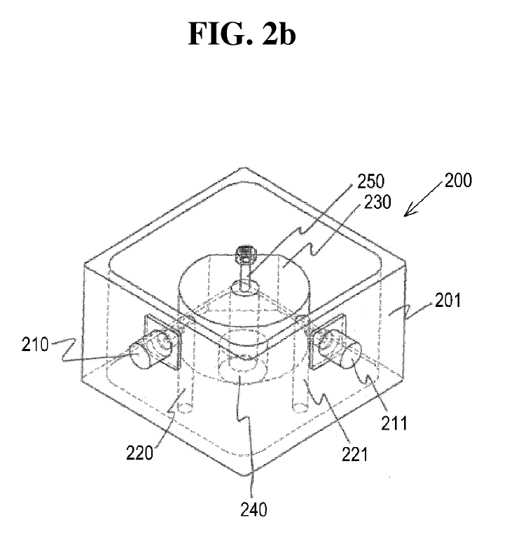

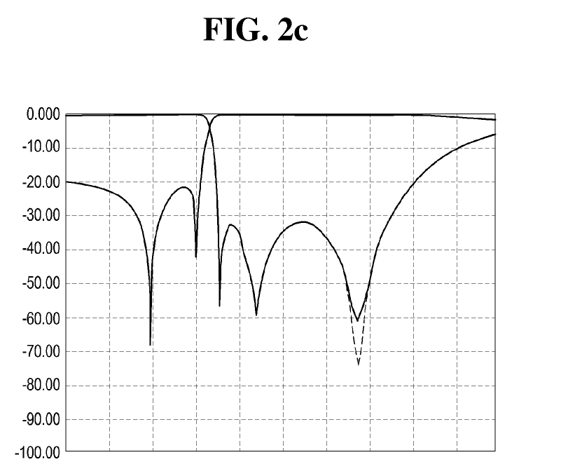

FIG. 2a is a perspective view of a multi-mode bandpass filter according to a first exemplary embodiment of the present invention, and FIG. 2b is a transmissive perspective view of the first exemplary embodiment of the present invention, in which illustration of a cover is omitted. According to the first exemplary embodiment of the present invention, a multi-mode bandpass filter 200 includes a housing 201 and a cover 202 that shield a cavity. The housing 201 and the cover 202 are made of a metallic material so as to shield an internal signal. Occasionally, the housing 201 and the cover 202 may be used in a state where they are coated with a non-conductive material such as a plastic.

In addition, input/output ports 210 and 211 are provided so as to input or output a signal to generate a resonance in the cavity.

In FIG. 2b, which is a transmissive perspective view of FIG. 2a, it can be seen that first and second transmission lines 220 and 221 are provided to be connected to the input/output ports. The two transmission lines 220 and 221 serve to couple energies required by the dielectric resonance element so as to implement a desired filter. Occasionally, the two transmission lines 220 and 221 may be electrically shorted or opened with respect to the housing 201 and a desired amount of energy coupling may be implemented by changing a distance between the transmission line and the dielectric resonance element, and a length, thickness, and shape of the transmission lines.

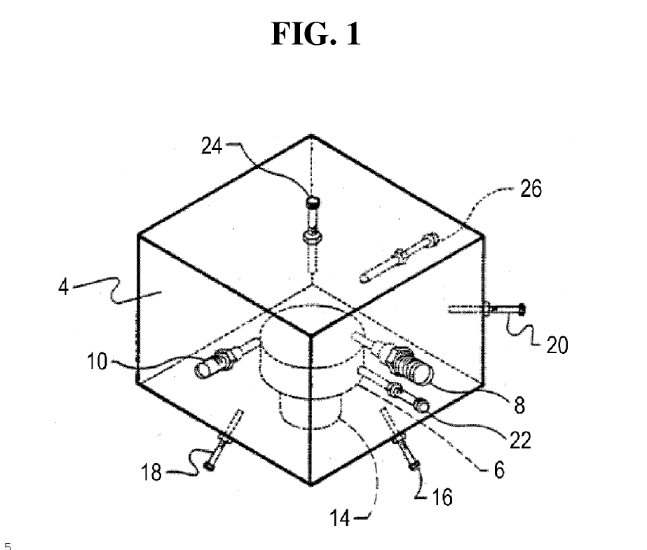

In addition, in the dielectric resonance element 230, respective frequency resonance modes for implementing the multi-mode bandpass filter 200 are generally generated to be directly related to a ratio of the diameter and the length of the dielectric resonance element 230. Accordingly, the respective resonance modes may be resonated at the same frequency through the adjustment of the ratio of the diameter and the length. However, in the present first exemplary embodiment, the dielectric resonance element 230 is manufactured in a doughnut shape in order to generate triple resonances as in the disclosure defined in claim 8, thereby facilitating the manufacturing of the dielectric resonance element 230 and dissipation of heat generated from the dielectric resonance element 230. That is, the entire external appearance of the dielectric resonance element 230 is similar to a cylindrical shape, but is formed with a through-hole is formed, for example, at the center thereof in a longitudinal direction. In addition, a dielectric resonance element 230, which is partially modified in shape as defined in claim 1, is provided without being provided with screws 16, 18, and 20 of FIG. 1 for energy coupling between respective frequency resonance modes of different multi-mode band resonance filters as disclosed in U.S. Pat. No. 4,675,630. Although the first exemplary embodiment executes energy coupling between multiple resonances by modifying a doughnut shape, it may also be applied to a cylindrical model and a rectangular model. The dielectric resonance element 230 used therefor typically uses a high dielectric permittivity as compared to a support 240, is made of a dielectric having a low-loss tangent coefficient, and has a low tangent, and thus the dielectric resonance element 230 may have a high selectivity Q (Quality factor) so that the loss caused in the filter can be reduced. The dielectric resonance element 230 may not be positioned at the center of the cavity, but is positioned at the center of the cavity in order to obtain the best selectivity Q (Quality factor).

Accordingly, the support 240, having a low dielectric permittivity and a low-loss tangent coefficient, is provided so as to position the dielectric resonance element 230 at the center of the cavity. The support 240 is in contact with the dielectric resonance element at one side thereof and in contact with the housing 201 at the opposite side. Typically, alumina (Al₂O₃) is used for the support because alumina has a low-loss tangent coefficient and is excellent in heat conductivity so that heat generated from the dielectric resonance element can be dissipated to the housing 201. Besides alumina, Teflon, a plastic or the like may be used.

A resonance adjustment screw 250 may be provided so as to finely adjust a resonance frequency.

FIG. 2c is a graph representing a characteristic measured for the multi-mode bandpass filter 200 according to the first exemplary embodiment which is provided as illustrated in FIGS. 2a and 2b. As illustrated in FIG. 2c, it can be seen that the multi-mode bandpass filter 200 according to the present invention generates a plurality of modes.

As described above with reference to FIGS. 2a to 2c, the present invention modifies a part of the doughnut-shaped dielectric resonance element 230 in order to generate multiple resonances, in which it can be seen that the modified structure is that a portion is removed in the plan structure of the dielectric resonance element 230 (i.e., in the example of FIGS. 2a and 2b, a structure obtained by cutting a portion from a circular shape). As the modified amount (the amount cut out from the circular shape) increases, a bandwidth may increase. In full measure, a semi-circle may be cut out. Such a modified amount may be properly designed in consideration of a desired filtering characteristic of the filter.

At this time, the first and second transmission lines 220 and 221 illustrated in FIG. 2b (and hence, the input/output ports) are configured to be positioned at an angle of 90 degrees in relation to each other with respect to the dielectric resonance element 230 on a plan view. Such an arrangement is an important configuration so as to generate two or more resonances in a single cavity. In addition, the modified portion in the dielectric resonance element 230 is formed preferably in a quadrant at an opposite side to a quadrant between the first and second transmission lines 220 and 221, which are positioned at the angle of 90 degrees in relation to each other on the plan view.

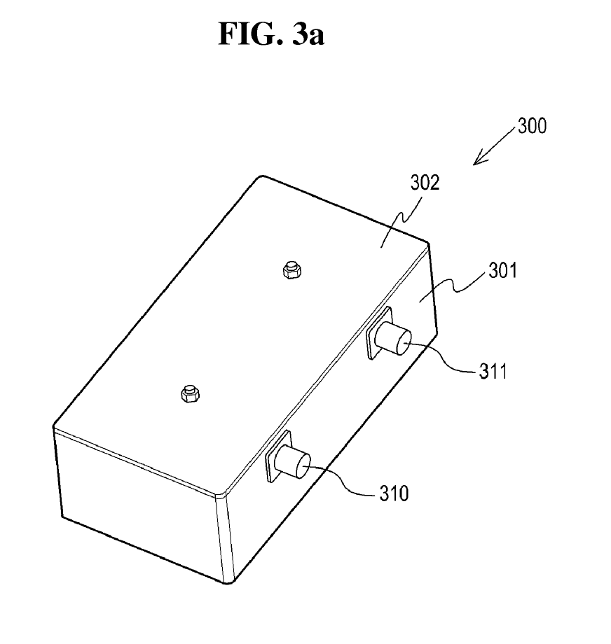

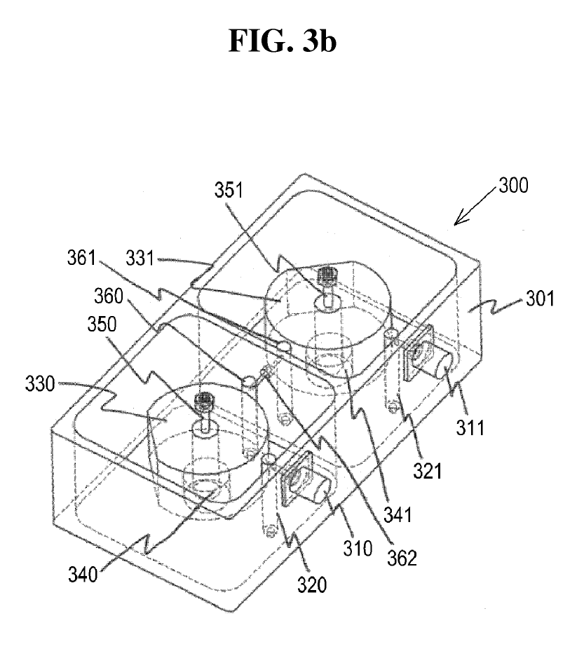

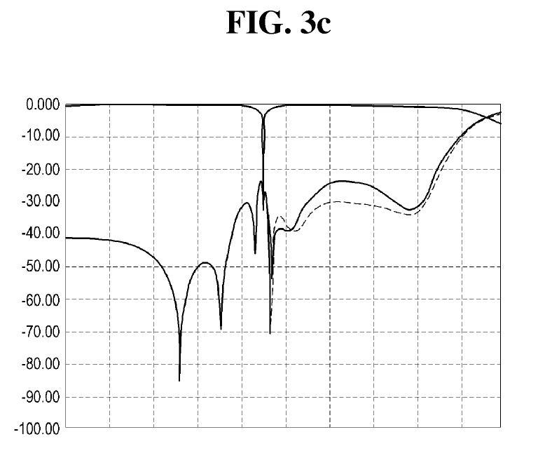

FIG. 3a is a perspective view of a multi-mode bandpass filter according to a second exemplary embodiment of the present invention, and FIG. 3b is a transmissive perspective view of the second exemplary embodiment of the present invention. The second exemplary embodiment extends a structure in which multiple resonances are generated in a single cavity as in the first exemplary embodiment of the present invention described above, to two cavities so as to implement a multi-mode bandpass filter 300. Although the second exemplary embodiment has been described assuming two cavities for the convenience of understanding, in practical use, the present invention may also be applied to all of two or more cavities.

Referring to FIGS. 3a and 3b, the multi-mode bandpass filter 300 is provided with a housing 301 and a cover 302. The housing and the cover are the same, in used material and use, as the housing 201 and the cover 202, respectively.

In addition, the multi-mode bandpass filter 300 includes input/output ports 310 and 311, and first and second transmission lines 320 and 321 which are the same, in used material and use, as the input/output ports 210, 211, and the first and second transmission line 220, 221 of the first exemplary embodiment, respectively.

In order to extend the first exemplary embodiment, two dielectric resonance elements 330 and 331, two supports 340 and 341, and resonance adjustment screws 350, 351 are provided and are the same, in material and use, as the resonance element 230, the support 240, and the resonance adjustment screw 250 of the first exemplary embodiment of the present invention, respectively.

However, third and fourth transmission lines 360 and 361 service to couple an energy required by the dielectric resonance elements 330 and 331 in order to implement a filter, and a fifth transmission line 362 is provided to interconnect the third and fourth transmission lines 360 and 361. Occasionally, the third and fourth transmission lines 360 and 361 may be electrically shorted or opened in relation to the housing 301 similar to the first and second transmission lines, and a desired amount of energy coupling may be implemented through a modification of a distance between the transmission lines and the dielectric resonance element, and the length, thickness and shape of the transmission lines.

FIG. 3c is a graph representing a characteristic measured for the multi-mode bandpass filter 300 according to the first exemplary embodiment which is provided as illustrated in FIGS. 3a and 3b.

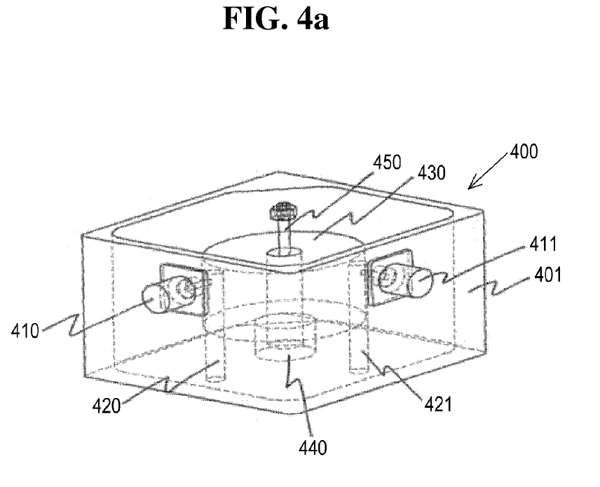

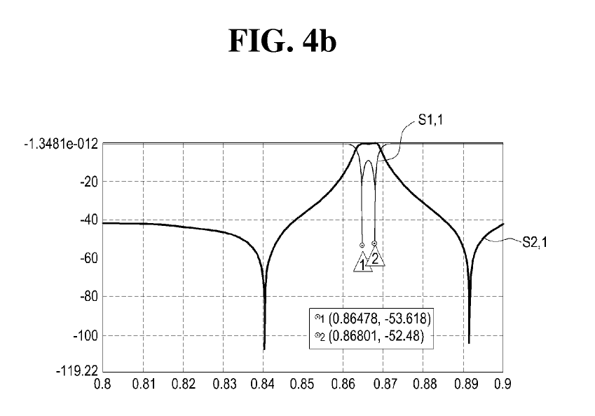

Hereinafter, other exemplary embodiments of the present invention will be described with reference to FIGS. 4a to 8. In the following description, for the convenience of description, illustration of the cover will be omitted, and descriptions of the functions thereof will also be omitted because they are the same as those described above.

FIG. 4a is a transmissive perspective view of the multi-mode bandpass filter according to a third exemplary embodiment of the present invention.

Referring to FIG. 4a, according to a third exemplary embodiment of the present invention, a multi-mode bandpass filter 400 includes a housing 401 and a cover that shield a cavity. The housing 401 and the cover are the same, in used material and use, as the housing 201 and the cover 202 of the first exemplary embodiment, respectively.

However, although the shape of the dielectric resonance element is partially modified for energy coupling between respective frequency resonance modes in the first and second exemplary embodiments, in the third exemplary embodiments, a shape of the housing 401 is partially modified for energy coupling between multiple resonances.

Further, the multi-mode bandpass filter 400 includes input/output ports 410 and 411, first and second transmission lines 420 and 421, a support 440, and a resonance adjustment screw 450 which are the same, in used material and use, as the input/output ports 210 and 211, first and second transmission lines 220 and 221, a support 240, and a resonance adjustment screw 250 of the first exemplary embodiment, respectively.

However, because energy coupling is executed by modifying a part of the shape of the housing 401, the dielectric resonance element 430 is provided in an ordinary doughnut shape (i.e., a non-modified structure).

FIG. 4b is a characteristic simulation graph for the multi-mode bandpass filter 200 according to the third exemplary embodiment of the present invention, which is provided as illustrated in FIG. 4a. As illustrated in FIG. 4b, it can be seen that the multi-mode bandpass filter 200 according to the third exemplary embodiment generates multiple modes.

As described above with reference to FIGS. 4a and 4b, in the third exemplary embodiment, an internal shape of the housing 401 (a shape of the cavity) is partially modified so as to generate multiple resonances. It can be seen that the modified structure is a structure in which a portion is added to the internal structure of the housing 401 to be opposite to the dielectric resonance element 430 (that is, in the example of FIG. 4a, a structure in which a corner portion in the internal structure of a rectangular view in a plan view is somewhat filled). As the modified amount (an amount filled in the corner) increases, the band width of the filter may increase. Such a modified amount may be properly designed in consideration of a desired filtering characteristic of the filter.

At this time, the first and second transmission lines 420 and 421 (and hence, the input/output ports) illustrated in FIG. 4a are configured to be positioned at an angle of 90 degrees in relation to each other with respect to the dielectric resonance element 230 on a plan view. At this time, the modified portion in the housing 401 is formed preferably in a quadrant at an opposite side to a quadrant between the first and second transmission lines 420 and 421 positioned at the angle of 90 in relation to each other on the plan view.

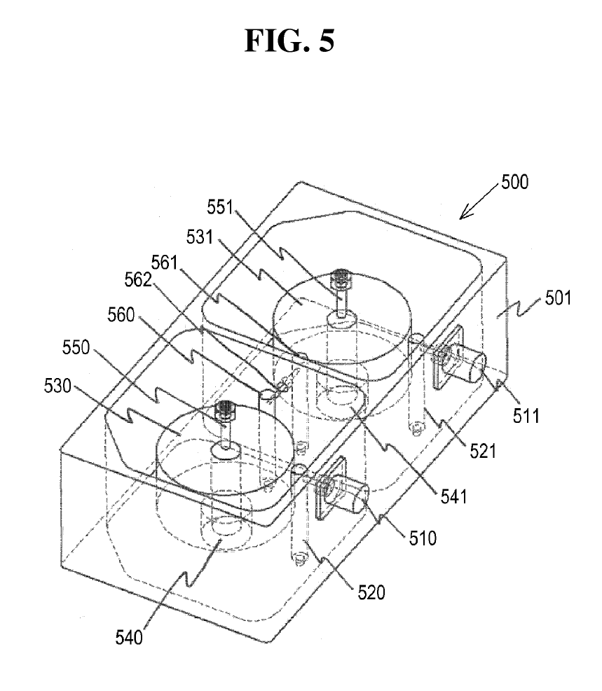

FIG. 5 is a transmissive perspective view of the multi-mode bandpass filter according to a fourth exemplary embodiment of the present invention. The fourth exemplary embodiment of the present invention implements a multi-mode bandpass filter 500 by extending a structure in which multiple resonances are generated in a single cavity as in the third exemplary embodiment described above, to a structure having two cavities. Although the fourth exemplary embodiment is described assuming two cavities for the convenience of understanding, in practical use, the present invention may also be applied to all of two or more cavities.

The multi-mode bandpass filter 500 includes a housing 501 and a cover. The housing and the cover are the same, in used material and use, as the housing 201 and the cover 202 of the first exemplary embodiment, respectively.

In addition, the multi-mode bandpass filter 500 includes input/output ports 510 and 511, and first and second transmission lines 520 and 521 which are the same, in used material and use, as the input/output ports 210, 211, and the first and second transmission line 220, 221 of the first exemplary embodiment, respectively.

In order to extend the third exemplary embodiment, two dielectric resonance elements 530 and 531, two supports 540 and 541, and resonance adjustment screws 550, 551 are provided and are the same, in material and use, as the resonance element 430, the support 440, and the resonance adjustment screw 450 of the third exemplary embodiment of the present invention, respectively.

In addition, the multi-mode bandpass filter 500 includes third, fourth, and fifth transmission lines 560, 561, and 562 which are the same, in used material and use, as the third, fourth, and fifth transmission lines 360, 361, and 362 of the second exemplary embodiment, respectively.

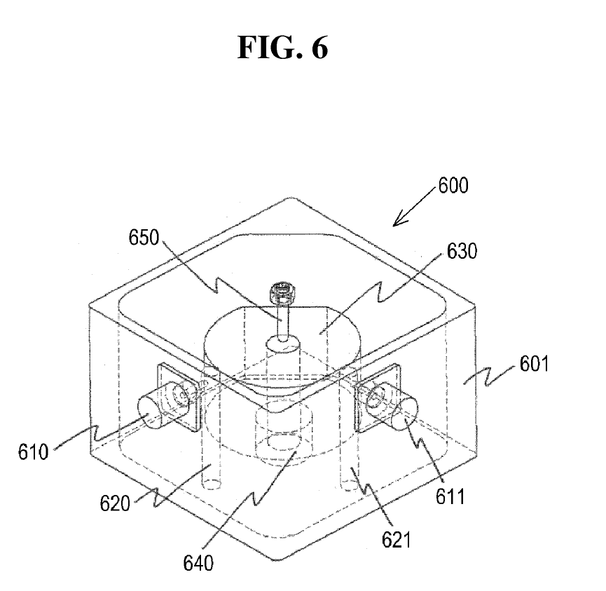

FIG. 6 is a transmissive perspective view of the multi-mode bandpass filter according to a fifth exemplary embodiment of the present invention. The fifth exemplary embodiment of the present invention is implemented by applying the first exemplary embodiment and the third exemplary embodiment described above to a single cavity. That is, a multi-mode bandpass filter 600 is implemented by partially modifying the shapes of both of the dielectric resonance element 630 and the housing 601 for energy coupling between multiple resonances in a single cavity.

The fifth exemplary embodiment illustrated in FIG. 6 may include input/output ports 610 and 611, first and second transmission lines 620 and 621, a support 640, and a resonance adjustment screw 650 as in the foregoing exemplary embodiments.

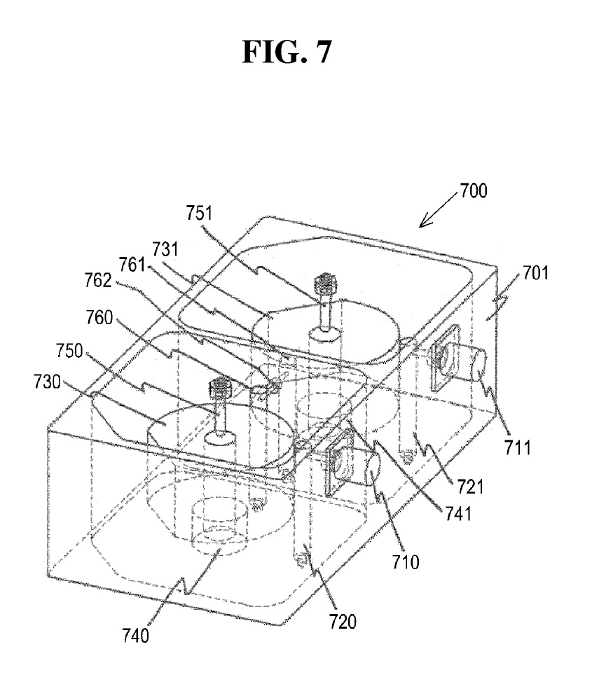

FIG. 7 is a transmissive perspective view of the multi-mode bandpass filter according to a sixth exemplary embodiment of the present invention. The sixth exemplary embodiment of the present invention implements a multi-mode bandpass filter 700 by extending a structure in which multiple resonances are generated in a single cavity as in the fifth exemplary embodiment described above, to a structure having two cavities. Although the sixth exemplary embodiment is described assuming two cavities for the convenience of understanding, in practical use, the present invention may also be applied to all of two or more cavities.

The sixth exemplary embodiment illustrated in FIG. 7 may include a housing 701, input/output ports 710 and 711, first and second transmission lines 720 and 721, dielectric resonance elements 730 and 731, supports 740 and 741, resonance adjustment screws 750 and 751, and third, fourth, and fifth transmission lines 760, 761, and 762 as in the foregoing exemplary embodiments.

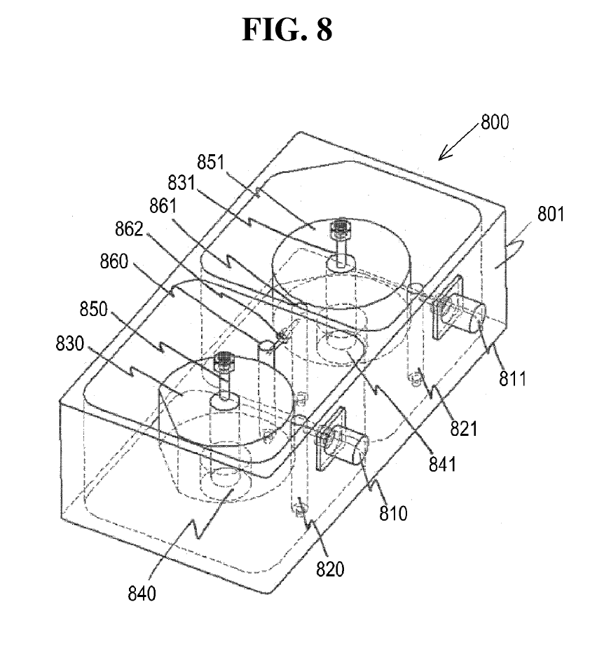

FIG. 8 is a transmissive perspective view of the multi-mode bandpass filter according to a seventh exemplary embodiment of the present invention. The seventh exemplary embodiment implements multiple resonance modes in two or more cavities by implementing the first and second exemplary embodiments described above in the cavities, respectively. That is, in at least one cavity, a shape of a dielectric resonance element is modified, and in at least one other cavity, a shape of the cavity is modified to implement a multi-mode bandpass filter 800.

The seventh exemplary embodiment illustrated in FIG. 8 may include a housing 801, input/output ports 810 and 811, first and second transmission lines 820 and 821, dielectric resonance elements 830 and 831, supports 840 and 841, resonance adjustment screws 850 and 851, and third, fourth, and fifth transmission lines 860, 861, and 862 as in the foregoing exemplary embodiments.

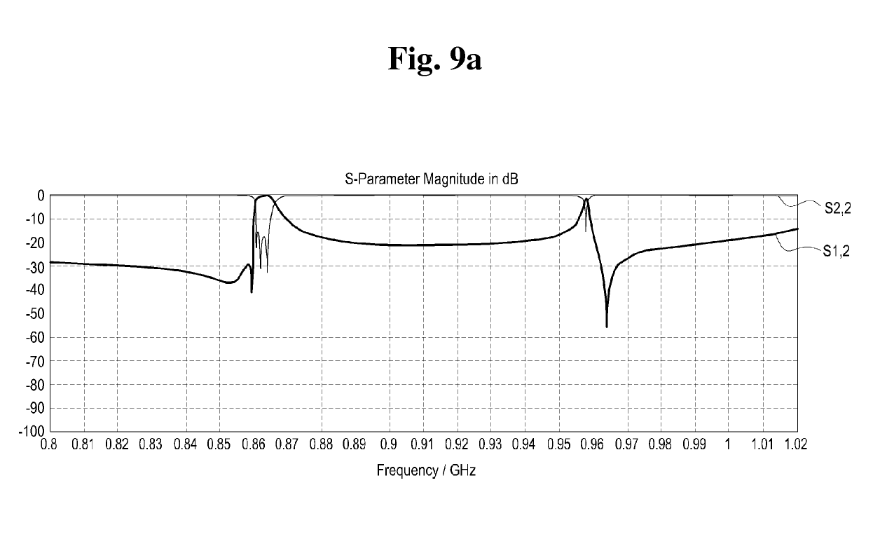

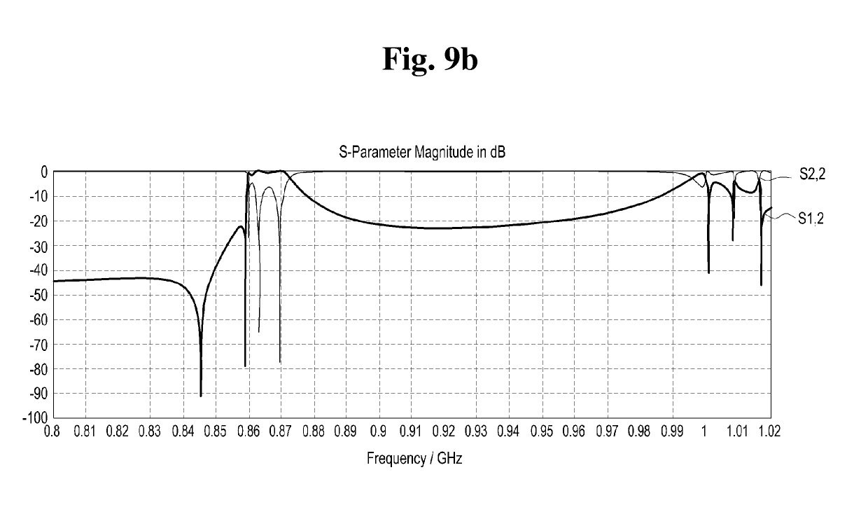

FIGS. 9a and 9b are graphs comparatively illustrating characteristics measured for multi-mode bandpass filters according to features of the present invention. FIG. 9a represents characteristic measurement results in a case where no through-hole exists in a central portion of the dielectric resonance element, and FIG. 9b represents characteristics in a case where a through-hole is formed in the central portion of the dielectric resonance element according to the present invention. As illustrated in FIGS. 9a and 9b, it can be found that when the through-hole is formed in the central portion of the dielectric resonance element, a spurious wave is generated at a frequency higher than a use frequency as compared to a structure where the through-hole is not formed, and thus forming the through-hole is more suitable in passing only a selected frequency which is a unique characteristic of a bandpass filter.

As described above, when a multi-mode bandpass filter may be configured according to the exemplary embodiments. In addition, other exemplary embodiments may be implements according to various modifications and changes of the present invention.

For example, a multi-mode bandpass filter structure including a single cavity or two cavities as illustrated in FIG. 5 or the like has been described in the foregoing description for the exemplary embodiment. Besides these, other exemplary embodiments of the present invention may similarly adopt a structure which is provided with a plurality of cavities, i.e. three or more cavities.

In addition, in the foregoing description, it has been described that in FIG. 5 or the like, an interconnecting coupling structure is adapted between a plurality of (e.g., two) cavities using third to fifth transmission lines. Besides this, in other exemplary embodiments of the present invention, it is also possible to adopt a structure that connects a plurality of cavities through windows formed by partially removing partition walls between the plurality of cavities.

1. A multi-mode bandpass filter comprising:
a housing that defines at least one cavity; and
a dielectric resonance element provided in the at least one cavity, a shape of the dielectric resonance element being partially modified so as to execute energy coupling between respective resonances when multiple resonances are generated.

2. The multi-mode bandpass filter of claim 1, wherein at least two cavities and at least two dielectric resonance elements are provided.

3. A multi-mode bandpass filter comprising:
a housing that defines at least one cavity, a shape of the at least one cavity being partially modified so as to execute energy coupling between respective resonances when multiple resonances; and
a dielectric resonance element provided in the at least one cavity.

4. The multi-mode bandpass filter of claim 3, wherein at least two cavities and at least two dielectric resonance elements are provided.

5. The multi-mode bandpass filter of claim 1, wherein a shape of the at least one cavity in the housing is partially modified.

6. The multi-mode bandpass filter of claim 2, wherein, among the at least two cavities in the housing, a shape of at least one cavity is partially modified.

7. The multi-mode bandpass filter of claim 1, wherein the dielectric resonance element is implemented in a doughnut shape.

8. The multi-mode bandpass filter of claim 1, wherein in the dielectric resonance element, the modified shape is a structure from which a portion is removed on a plan view.

9. The multi-mode bandpass filter of claim 8, further comprising:
first and second transmission lines that couples an input/output signal of the cavity or cavities, the first and second transmission lines being positioned at an angle of 90 degrees in relation to each other on a plan view,
wherein the portion modified in the dielectric resonance element is positioned in a quadrant at a side opposite to a quadrant between the first and second transmission lines which are positioned at an angle of 90 degrees in relation to each other on a plan view.
